(19) United States
(12) Patent Application Publication
(10) Pub. No.: US 2025/0188763 A1
(43) Pub. Date: Jun. 12, 2025

(54) CASTER ASSEMBLY AND PARKING ROBOT INCLUDING THE SAME

(71) Applicant: HL MANDO CORPORATION, Gyeonggi-do (KR)

(72) Inventors: Jeongjae PARK, Gyeonggi-do (KR); Dongseon KIM, Gyeonggi-do (KR); Joonkyu SONG, Gyeonggi-do (KR); Seongho CHOI, Gyeonggi-do (KR)

(21) Appl. No.: 18/972,607

(22) Filed: Dec. 6, 2024

(30) Foreign Application Priority Data
Dec. 7, 2023 (KR) 10-2023-0176751
Aug. 21, 2024 (KR) 10-2024-0112412

(51) Int. Cl. E04H 6/42; B60B 33/00; B60P 3/07

(52) U.S. Cl. CPC E04H 6/424; B60B 33/0049; B60B 33/0068; B60P 3/07; B60B 2380/90

(57) ABSTRACT

Disclosed are a caster assembly and a parking robot including the same. The present embodiment relates to a caster assembly and a parking robot including the same, the caster assembly including a bearing configured such that an inner race rotates relative to an outer race, a bearing casing to which the bearing is fixedly coupled so that at least a part of the outer race is supported on an inner circumferential surface of the bearing casing, a bearing upper cover provided to surround at least a part of the inner race, except for a bottom surface of the inner race, and rotatably coupled to the inner circumferential surface of the bearing casing, a bearing lower cover provided to support at least a part of the bottom surface of the inner race and fastened to a lower side of the bearing upper cover, and a wheel protruding downward from a top surface of the bearing upper cover and rotatably coupled to the bearing upper cover or the bearing lower cover.

### CROSS-REFERENCE TO RELATED APPLICATIONS

This application claims the priority of Korean Patent Application No. 10-2023-0176751 filed on Dec. 7, 2023, in the Korean Intellectual Property Office and the priority of Korean Patent Application No. 10-2024-0112412 filed on Aug. 21, 2024, in the Korean Intellectual Property Office, the disclosure of which is incorporated herein by reference.

### BACKGROUND

### Field

The present disclosure relates to a caster assembly and a parking robot including the same, and more particularly, to a caster assembly, which is capable of preventing an increase in height from a support surface of a wheel without decreasing a size of the wheel, and a parking robot including the same.

### Description of the Related Art

The number of vehicles is increasing, but parking spaces are limited. Therefore, policies and technical studies are being consistently conducted to solve the shortage of parking spaces. In particular, automated parking systems are being actively developed to efficiently park a large number of vehicles at a limited location in a structure, such as a parking tower or an underground parking facility, having a plurality of parking spaces.

In general, the automatic parking system may include a pallet onto which the vehicle is loaded, and a conveyance mechanism configured to convey the pallet to a designated parking space. However, the automatic parking system needs to have the pallets for respective designated parking spaces including a designated initial space that allows the vehicle to enter or exit the automatic parking system. For this reason, there is a problem in that the amount of costs required to manufacture the system is comparatively large, and the structure is also complicated.

In order to solve this problem, recently, a parking robot has been developed and proliferated, and the parking robot is capable of entering a front wheel side and a rear wheel side through a lower space of the vehicle, raising the vehicle from a ground surface, and then conveying the vehicle to a designated parking space.

In general, the parking robot includes a lifting device configured to raise the vehicle from the ground surface or lower the vehicle, a drive device configured to move to a designated parking space in a state in which the vehicle is loaded onto the lifting device or to enter or exit a lower side of the vehicle in a state in which no vehicle is loaded, and a battery or the like configured to supply power to the lifting device or the drive device. For this reason, there is a problem in that the entire size of the parking robot is increased, which makes it difficult to manage light vehicles that occupy a comparatively small entrance space in the parking robot.

Meanwhile, casters refer to mobile wheels installed on lower surfaces of various mobile means such as pallets or mobile shelves, on which freight and the like are loaded and conveyed, wheelchairs, travel carriers, and the like in order to allow the mobile means to move smoothly. The caster may also be applied to the parking robot. As a diameter of a wheel of the caster increases, the traveling performance of the mobile means may be improved, and the durability of the mobile means against loads may be improved. Therefore, a wheel with a large diameter is generally applied to the caster applied to the parking robot on which a vehicle with a comparatively heavy weight is loaded. However, there is a problem of an increase in height of the parking robot from a support surface on which the wheel is supported.

Accordingly, the parking robot needs to be equipped with a caster capable of ensuring traveling performance and durability and having a minimized height so that the parking robot may enter a space between a ground surface and a bottom surface of a vehicle having a comparatively small height.

### SUMMARY

An object to be achieved by the present embodiment is to provide a caster assembly capable of being equipped with a wheel with a sufficient diameter to ensure traveling performance and durability to smoothly move a parking robot on which freight with a comparatively heavy weight is loaded, and minimizing an increase in height caused by a large diameter of the wheel.

Another object to be achieved by the present embodiment is to provide a caster assembly optimized to be applied to a parking robot configured to enter a front wheel side and a rear wheel side of a vehicle, lift the vehicle from a ground surface, and then convey the vehicle to a designated parking location, and a parking robot including the same.

An embodiment of the present disclosure provides a caster assembly including: a bearing configured such that an inner race rotates relative to an outer race; a bearing casing to which the bearing is fixedly coupled so that at least a part of the outer race is supported on an inner circumferential surface of the bearing casing; a bearing upper cover provided to surround at least a part of the inner race, except for a bottom surface of the inner race, and rotatably coupled to the inner circumferential surface of the bearing casing; a bearing lower cover provided to support at least a part of the bottom surface of the inner race and fastened to a lower side of the bearing upper cover; and a wheel protruding downward from a top surface of the bearing upper cover and rotatably coupled to the bearing upper cover or the bearing lower cover.

The bearing casing may include: a bearing casing body configured to support an outer circumferential surface of the outer race; and a first bearing casing flange protruding inward from an upper portion of the bearing casing body and configured to support a top surface of the outer race.

The bearing casing may include: a second bearing casing flange protruding outward from a lower portion of the bearing casing body; and a plurality of bearing casing fastening holes penetratively formed from a top surface to a bottom surface along a circumferential surface of the second bearing casing flange.

The bearing upper cover may include: a bearing upper cover body having a disc shape and configured to support an inner circumferential surface of the inner race; a bearing upper cover flange protruding outward from an upper portion of the bearing upper cover body and configured to support a top surface of the inner race; and a bearing upper cover opening penetratively formed from a top surface to a bottom surface of the bearing upper cover body so that at least a part of the wheel is disposed in the bearing upper cover opening.

The bearing upper cover may further include a plurality of bearing upper cover fastening holes penetratively formed from the top surface to the bottom surface of the bearing upper cover body so that fastening members for fastening the bearing lower cover are inserted into the plurality of bearing upper cover fastening holes.

The bearing lower cover may include: a bearing lower cover opening penetratively formed from a top surface to a bottom surface of the bearing lower cover so that at least a part of the wheel is disposed in the bearing lower cover opening; first wheel fastening parts respectively provided at two opposite sides of the bearing lower cover opening and protruding downward from the bottom surface of the bearing lower cover; and first wheel pin fixing holes penetratively formed from one side to the other side of the first wheel fastening part, and the bearing lower cover may be provided in a disc shape.

The bearing lower cover may further include a plurality of bearing lower cover fastening holes penetratively formed from the top surface to the bottom surface of the bearing lower cover so that fastening members for fastening the bearing upper cover are inserted into the plurality of bearing lower cover fastening holes.

The wheel may include: a wheel pin through-hole provided along a rotation axis of the wheel; and a wheel pin coupled to the wheel pin through-hole and having two opposite ends fixed to the first wheel pin fixing holes.

A diameter of the wheel may be equal to a length of a bearing upper cover opening penetratively formed from the top surface to the bottom surface of the bearing upper cover so that at least a part of the wheel is disposed in the bearing upper cover opening, and the diameter of the wheel may be equal to a length of a bearing lower cover opening penetratively formed from the top surface to the bottom surface of the bearing lower cover so that at least a part of the wheel is disposed in the bearing lower cover opening.

The bearing lower cover may further include a first wheel pin insertion groove provided in the bottom surface of the bearing lower cover in a direction toward a central axis of the first wheel pin fixing hole so that a part of the wheel pin is inserted into the first wheel pin insertion groove.

The bearing upper cover may further include: second wheel fastening parts respectively provided at two opposite sides of the bearing upper cover opening and protruding downward from the bottom surface of the bearing upper cover body; and second wheel pin fixing holes penetratively formed from one side to the other side of the second wheel fastening part.

The bearing lower cover may include a plurality of bearing lower cover fastening holes penetratively formed from the top surface to the bottom surface of the bearing lower cover so that fastening members for fastening the bearing upper cover are inserted into the plurality of bearing lower cover fastening holes.

The wheel may include: a wheel pin through-hole provided along a rotation axis of the wheel; and a wheel pin coupled to the wheel pin through-hole and having two opposite ends fixed to the second wheel pin fixing holes.

The bearing lower cover may further include a second wheel pin insertion groove provided in the bottom surface of the bearing lower cover in a direction toward a central axis of the second wheel pin fixing hole so that a part of the wheel pin is inserted into the second wheel pin insertion groove.

A diameter of the wheel may be equal to a length of the bearing upper cover opening.

Another embodiment of the present disclosure provides a parking robot, which includes the above-mentioned caster assembly and is configured to enter a front wheel side and a rear wheel side of a vehicle, lift the vehicle from a ground surface, and then transport the vehicle to a designated parking location, the parking robot including: a first drive module provided at one side of a front side; a second drive module provided at one side of a rear side; a first lifting module provided between the first drive module and the second drive module; and a second lifting module coupled to the caster assembly and provided at the other side of the first lifting module.

The first drive module may include two first driving wheels provided at two opposite ends of a first driving shaft and configured to operate independently of each other, the second drive module may include two second driving wheels provided at two opposite ends of a second driving shaft and configured to operate independently of each other, and the parking robot may be configured to move straight or rotate in accordance with rotations of the first and second driving wheels.

The first lifting module may include two first lift bars configured to be simultaneously deployed by being rotated about first rotation shafts provided at front and rear sides of the first lifting module, the second lifting module may include two second lift bars configured to be simultaneously deployed by being rotated about second rotation shafts provided at front and rear sides of the second lifting module, and the parking robot may be configured to lift the vehicle from the ground surface when the first lift bars and the second lift bars are deployed.

The caster assembly may be formed such that a top surface of the bearing casing and a top surface of the bearing upper cover are formed at the same height as a top surface of the second lifting module.

The parking robot may further include: a first control module provided forward of the second lifting module; a second control module provided rearward of the second lifting module; a battery module provided between the first lifting module and the second lifting module and provided adjacent to the first drive module and the first control module; and a third control module provided between the first lifting module and the second lifting module and provided adjacent to the second drive module and the second control module.

The caster assembly according to the present embodiment may be equipped with the wheel with a sufficient diameter to ensure the traveling performance and durability to smoothly convey the parking robot on which freight with a comparatively heavy weight is loaded. Further, the caster assembly according to the present embodiment may minimize an increase in height caused by a large diameter of the wheel. Therefore, the caster assembly according to the present embodiment may be used for various mobile means, such as transport carriage, wheelchairs, and travel carriers, including the parking robot that moves in the state in which a heavy-weight vehicle is loaded onto the parking robot.

The parking robot, which includes the caster assembly according to the present embodiment and is configured to enter the front wheel side and the rear wheel side of the vehicle, lift the vehicle from the ground surface, and then convey the vehicle to a designated parking location, prevents a height of the parking robot from being increased by a height of the caster assembly. Therefore, it is possible to solve a problem in that the parking robot cannot enter the location between the ground surface and the bottom surface of the vehicle because of a height limitation.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view illustrating a state in which a caster assembly according to the embodiment of the present disclosure is disassembled;

FIG. 2 is a perspective view illustrating a state in which the caster assembly according to the embodiment of the present disclosure illustrated in FIG. 1 is assembled;

FIG. 3 is a cross-sectional view illustrating a cross-section taken along line A-A′ in FIG. 2;

FIG. 4 is a bottom plan view of the caster assembly according to the embodiment of the present disclosure illustrated in FIG. 2;

FIG. 5 is an exploded perspective view illustrating a state in which the caster assembly according to the embodiment of the present disclosure is disassembled;

FIG. 6 is a top plan view illustrating a state in which the caster assembly according to the embodiment of the present disclosure illustrated in FIG. 5 is assembled;

FIG. 7 is a bottom plan view of the caster assembly according to the embodiment of the present disclosure illustrated in FIG. 5;

FIG. 8 is a cross-sectional view illustrating a cross-section taken along line B-B′ in FIG. 6;

FIG. 9 is a perspective view illustrating a non-deployed state of a parking robot including the caster assembly according to the embodiment of the present disclosure;

FIG. 10 is a perspective view illustrating a deployed state of the parking robot including the caster assembly according to the embodiment of the present disclosure; and

FIG. 11 is a top plan view illustrating a state in which a vehicle is lifted by the parking robot including the caster assembly according to the embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, embodiments of the present disclosure will be described in detail with reference to the accompanying drawings. The following embodiments are presented to sufficiently provide the spirit of the present disclosure to those skilled in the art to which the present disclosure pertains. The present disclosure is not limited to the embodiments presented herein and may be specified as other aspects. The constituent elements irrelevant to the description of the present disclosure will be omitted from the drawings to clearly describe the present disclosure. The sizes of the constituent be exaggerated for purposes elements may somewhat of understanding.

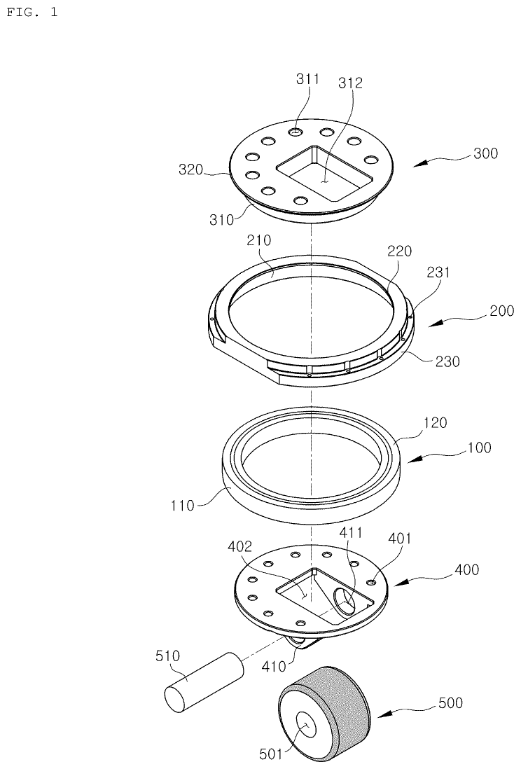

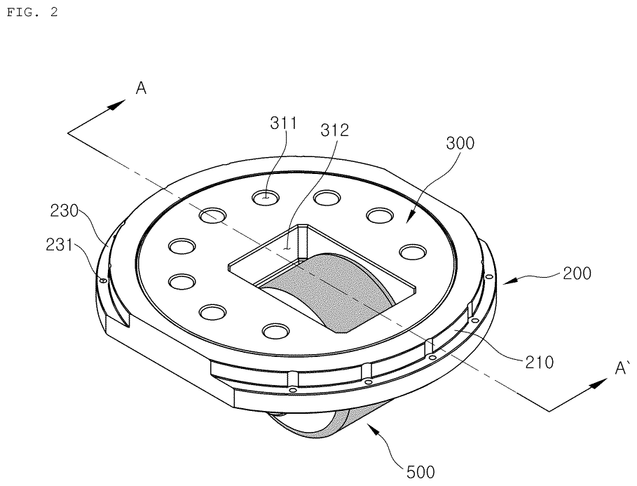

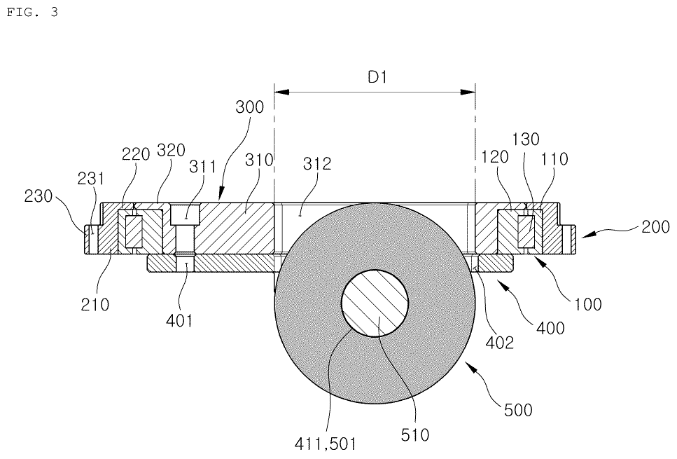

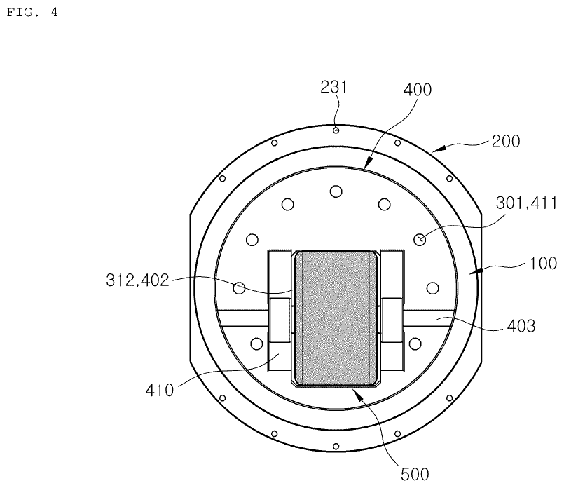

FIG. 1 is an exploded perspective view illustrating a state in which a caster assembly according to the embodiment of the present disclosure is disassembled, and FIG. 2 is a perspective view illustrating a state in which the caster assembly according to the embodiment of the present disclosure illustrated in FIG. 1 is assembled. In addition, FIG. 3 is a cross-sectional view illustrating a cross-section taken along line A-A′ in FIG. 2, and FIG. 4 is a bottom plan view of the caster assembly according to the embodiment of the present disclosure illustrated in FIG. 2.

With reference to FIGS. 1 to 4, the caster assembly according to the embodiment of the present disclosure may include a bearing 100, a bearing casing 200, a bearing upper cover 300, a bearing lower cover 400, and a wheel 500. In this case, the wheel 500 may be rotatably coupled to the bearing lower cover 400.

The bearing 100 may be configured such that an inner race 120 is rotatable relative to an outer race 110. In addition, as illustrated in FIG. 3, the bearing 100 may have a rectangular cross-sectional shape and further include a plurality of rolling parts 130 provided between the outer race 110 and the inner race 120 and configured to rotate the inner race 120 relative to the outer race 110. For example, the bearing 100 may be a ball bearing in which the rolling part 130 has a spherical shape or a roller bearing in which the rolling part 130 has a cylindrical roller shape.

Meanwhile, the bearing 100 may be fixedly coupled to the bearing casing 200 so that at least a part of the outer race 110 is supported on an inner circumferential surface of the bearing casing 200. To this end, the bearing casing 200 may include a bearing casing body 210 configured to support an outer circumferential surface of the outer race 110, and a first bearing casing flange 220 protruding inward from an upper portion of the bearing casing body 210 and configured to support a top surface of the outer race 110.

In addition, the bearing casing 200 may further include a second bearing casing flange 230 protruding outward from a lower portion of the bearing casing body 210, and a plurality of bearing casing fastening holes 231 penetratively formed along a circumferential surface of the second bearing casing flange 230 from a top surface to a bottom surface of the second bearing casing flange 230 so that the caster assembly according to the embodiment of the present disclosure may be installed on a lower portion of a transport means such as a parking robot.

Meanwhile, the bearing upper cover 300 may be provided to surround at least a part of the inner race 120 and rotatably coupled to an inner circumferential surface of the bearing casing 200. To this end, the bearing upper cover 300 may include a bearing upper cover body 310 having a disc shape and configured to support an inner circumferential surface of the inner race 120, a bearing upper cover flange 320 protruding outward from an upper portion of the bearing upper cover body 310 and configured to support a top surface of the inner race 120, and a bearing upper cover opening 312 penetratively formed from a top surface to a bottom surface of the bearing upper cover body 310 so that at least a part of the wheel 500 is disposed in the bearing upper cover opening 312.

In this case, the bearing upper cover opening 312 may have a shape identical or similar to that of a transverse section of the wheel 500 so that at least a part of the wheel 500 may be disposed in the bearing upper cover opening 312, as described above. In addition, the bearing upper cover opening 312 may be formed so that at least any one of imaginary perpendicular intersection lines, which pass through a rotation axis of the bearing 100, and an imaginary straight line, which passes through a center of the bearing upper cover opening 312 in a longitudinal direction of the bearing upper cover opening 312, are disposed on the same line on a plane corresponding to the top surface or the bottom surface of the bearing upper cover body 310.

In addition, in the caster assembly according to the embodiment of the present disclosure, a height of the bearing upper cover body 310 is equal to a height of the bearing casing body 210, such that the bearing upper cover 300 and the bearing casing 200 may have the top surfaces and the bottom surfaces at the same heights when the bearing upper cover 300 is fixed to the inner race 120 and the bearing casing 200 is fixed to the outer race 110.

In addition, the bearing upper cover 300 may further include a plurality of bearing upper cover fastening holes 311 penetratively formed from the top surface to the bottom surface of the bearing upper cover body 310 so that fastening members (not illustrated) for fastening the bearing lower cover 400 are inserted into the plurality of bearing upper cover fastening holes 311. In this case, the plurality of bearing upper cover fastening holes 311 may be formed at preset intervals along a circumferential surface of the bearing upper cover body 310 having a disc shape.

Meanwhile, the bearing lower cover 400 may be fastened to a lower side of the bearing upper cover 300 and provided to support at least a part of a bottom surface of the inner race 120. To this end, the bearing lower cover 400 may be provided in a disc shape so that a top surface thereof supports the bottom surface of the inner race 120 along the outer circumference.

In addition, the bearing lower cover 400 may include a bearing lower cover opening 402 penetratively formed from a top surface to a bottom surface of the bearing lower cover 400 so that at least a part of the wheel 500 is disposed in the bearing lower cover opening 402, first wheel fastening parts 410 provided at two opposite sides of the bearing lower cover opening 402 and protruding downward from the bottom surface of the bearing lower cover 400, and first wheel pin fixing holes 411 penetratively formed from one side to the other side of the first wheel fastening parts 410.

In this case, like the bearing upper cover opening 312, the bearing lower cover opening 402 may have a shape identical or similar to that of the transverse section of the wheel 500 so that at least a part of the wheel 500 may be disposed in the bearing lower cover opening 402.

In addition, the bearing lower cover opening 402 may be formed so that at least any one of imaginary perpendicular intersection lines, which pass through the rotation axis of the bearing 100, and an imaginary straight line, which passes through a center of the bearing lower cover opening 402 in a longitudinal direction of the bearing lower cover opening 402, are disposed on the same line on a plane corresponding to the top surface or the bottom surface of the bearing lower cover 400. Therefore, the bearing lower cover opening 402 may be stacked below the bearing upper cover opening 312 and provided to define one opening penetratively formed from the top surface of the bearing upper cover body 310 to the bottom surface of the bearing lower cover 400 so that a part of the upper side of the wheel 500 may be disposed in the opening.

In addition, the bearing lower cover 400 may further include a plurality of bearing lower cover fastening holes 401 penetratively formed from the top surface to the bottom surface of the bearing lower cover 400 so that fastening members (not illustrated) for fastening the bearing upper cover 300 are inserted into the plurality of bearing lower cover fastening holes 401. In this case, like the bearing upper cover fastening holes 311, the plurality of bearing lower cover fastening holes 401 may be formed at preset intervals along a circumferential surface of the bearing lower cover 400 having an annular shape.

Therefore, in the caster assembly according to the embodiment of the present disclosure, the fastening members (not illustrated) for coupling the bearing upper cover 300 and the bearing lower cover 400 are inserted into the bearing upper cover fastening holes 311, pass through the bearing lower cover fastening holes 401, and are fixed to the bottom surface of the bearing lower cover 400, such that the bearing upper cover 300 and the bearing lower cover 300, which are coupled to the bearing 100 to surround the top surface, the inner circumferential surface, and the bottom surface of the inner race 120, may rotate together about the rotation axis of the bearing 100 from the outer race 110.

In addition, as illustrated in FIG. 4, the bearing lower cover 400 may further include a first wheel pin insertion groove 403 provided in the bottom surface of the bearing lower cover 400 in a direction toward a central axis of the first wheel pin fixing hole 411 so that a part of a wheel pin 510 for coupling the wheel 500 to the first wheel fastening part 410 may be inserted into the first wheel pin insertion groove 403. Therefore, the caster assembly according to the embodiment of the present disclosure may further minimize a height of the caster assembly from the support surface on which the wheel 500 is supported so that the wheel 500 rotates.

Meanwhile, the wheel 500 may be rotatably coupled to the bearing lower cover 400 so as to protrude from the top surface of the bearing upper cover 300 toward the bottom surface of the bearing lower cover 400. To this end, the wheel 500 may include a wheel pin through-hole 501 provided along a rotation axis of the wheel 500, and the wheel pin 510 coupled to the wheel pin through-hole 501 and having two opposite ends fixed to the first wheel pin fixing holes 411. In this case, although not illustrated, the wheel pin 510 may further include a structure such as a groove or a protrusion so that the two opposite ends of the wheel pin 510 may be fixed to the first wheel pin fixing holes 411. In addition, the wheel 500 may further include a bearing provided in the wheel pin through-hole 501 to improve rolling performance.

In addition, in the caster assembly according to the embodiment of the present disclosure, in case that a diameter and a width of the wheel 500 are smaller than lengths and widths of the bearing upper cover opening 312 and the bearing lower cover opening 402, the rotation axis of the wheel 500 may be provided to be high toward the bearing upper cover 300 to further minimize the height of the caster assembly. However, in order to prevent foreign substances from being introduced into a space between the wheel 500, the bearing upper cover opening 312, and the bearing lower cover opening 402, a diameter D1 and a width of the wheel 500 may be identical or similar to a length and a width of each of the bearing upper cover opening 312 and the bearing lower cover opening 402, as illustrated in FIGS. 3 and 4.

In addition, an upper end of the wheel 500 does not protrude from the top surface of the bearing upper cover 300 and the top surface of the bearing casing 200, such that the transport means to which the caster assembly according to the embodiment of the present disclosure is coupled may exclude a structure or the like for preventing contact with the wheel 500.

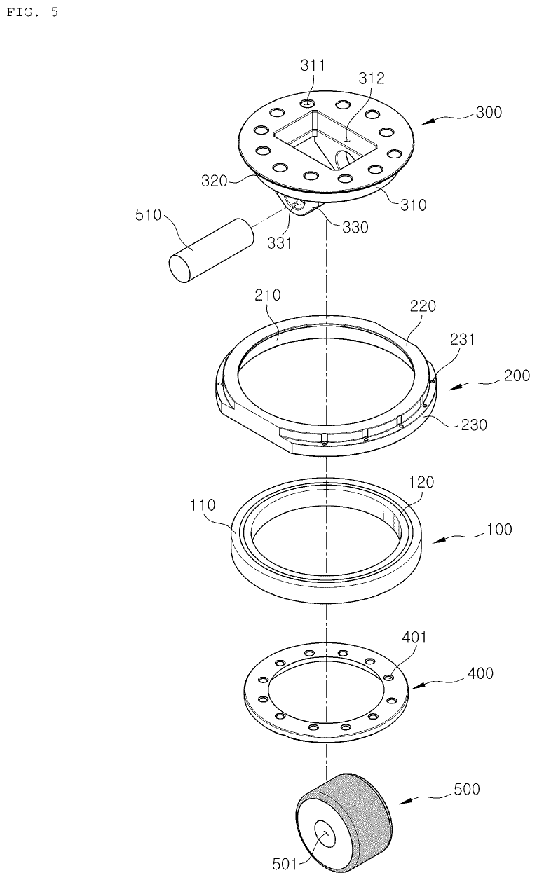

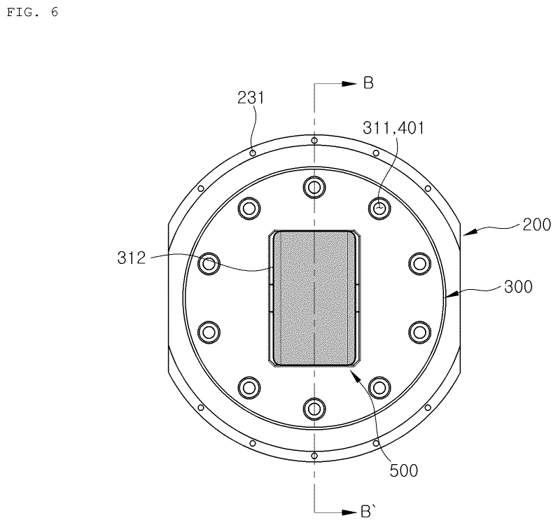

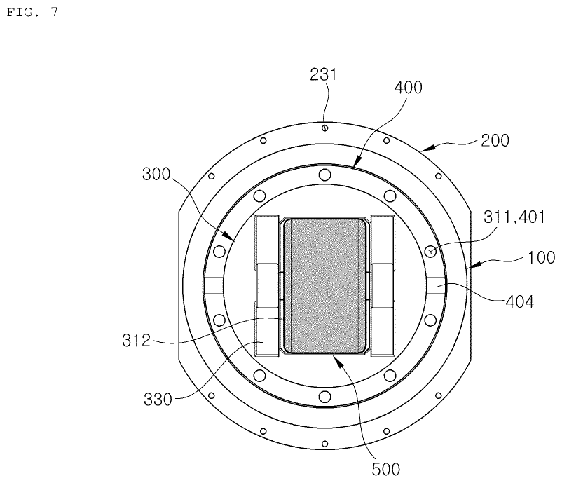

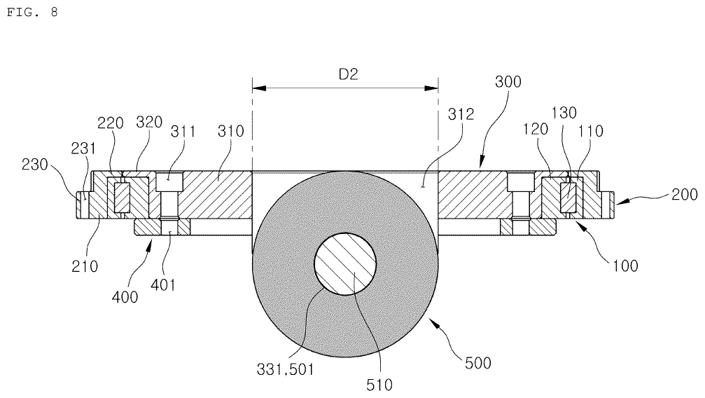

Meanwhile, FIG. 5 is an exploded perspective view illustrating a state in which the caster assembly according to the embodiment of the present disclosure is disassembled. In addition, FIGS. 6 and 7 are respectively a top plan view and a bottom plan view illustrating a state in which the caster assembly according to the embodiment of the present disclosure illustrated in FIG. 5 is assembled. In addition, FIG. 8 is a cross-sectional view illustrating a cross-section taken along line B-B′ in FIG. 6.

With reference to FIGS. 5 to 8, the caster assembly according to the embodiment of the present disclosure may include the bearing 100, the bearing casing 200, the bearing upper cover 300, the bearing lower cover 400, and the wheel 500. In this case, the wheel 500 may be rotatably coupled to the bearing upper cover 300.

The bearing 100 may be configured such that the inner race 120 is rotatable relative to the outer race 110. In addition, as illustrated in FIG. 3, the bearing 100 may have a rectangular cross-sectional shape and further include the plurality of rolling parts 130 provided between the outer race 110 and the inner race 120 and configured to rotate the inner race 120 relative to the outer race 110. For example, the bearing 100 may be a ball bearing in which the rolling part 130 has a spherical shape or a roller bearing in which the rolling part 130 has a cylindrical roller shape.

Meanwhile, the bearing 100 may be fixedly coupled to the bearing casing 200 so that at least a part of the outer race 110 is supported on the inner circumferential surface of the bearing casing 200. To this end, the bearing casing 200 may include the bearing casing body 210 configured to support the outer circumferential surface of the outer race 110, and the first bearing casing flange 220 protruding inward from the upper portion of the bearing casing body 210 and configured to support the top surface of the outer race 110.

In addition, the bearing casing 200 may further include the second bearing casing flange 230 protruding outward from the lower portion of the bearing casing body 210, and the plurality of bearing casing fastening holes 231 penetratively formed along the circumferential surface of the second bearing casing flange 230 from the top surface to the bottom surface of the second bearing casing flange 230 so that the caster assembly according to the embodiment of the present disclosure may be installed on the lower portion of the transport means such as the parking robot.

Meanwhile, the bearing upper cover 300 may be provided to surround at least a part of the inner race 120 and rotatably coupled to the inner circumferential surface of the bearing casing 200. To this end, the bearing upper cover 300 may include the bearing upper cover body 310 having a disc shape and configured to support the inner circumferential surface of the inner race 120, the bearing upper cover flange 320 protruding outward from the upper portion of the bearing upper cover body 310 and configured to support the top surface of the inner race 120, and the bearing upper cover opening 312 penetratively formed from the top surface to the bottom surface of the bearing upper cover body 310 so that at least a part of the wheel 500 is disposed in the bearing upper cover opening 312.

In this case, the bearing upper cover opening 312 may have a shape identical or similar to that of the transverse section of the wheel 500 so that at least a part of the wheel 500 may be disposed in the bearing upper cover opening 312, as described above. In addition, the bearing upper cover opening 312 may be formed such that the rotation axis of the bearing 100 and the center of the bearing upper cover opening 312 are disposed on the same perpendicular line.

In addition, in the caster assembly according to the embodiment of the present disclosure, the height of the bearing upper cover body 310 is equal to the height of the bearing casing body 210, such that the bearing upper cover 300 and the bearing casing 200 may have the top surfaces and the bottom surfaces at the same heights when the bearing upper cover 300 is fixed to the inner race 120 and the bearing casing 200 is fixed to the outer race 110.

In addition, the bearing upper cover 300 may further include second wheel fastening parts 330 provided at two opposite sides of the bearing upper cover opening 312 and protruding downward from the bottom surface of the bearing upper cover body 310, and second wheel pin fixing holes 331 penetratively formed from one side to the other side of the second wheel fastening parts 330.

Therefore, in the caster assembly according to the embodiment of the present disclosure, the wheel 500 may be rotatably coupled to the bearing upper cover 300 so as to protrude from the top surface of the bearing upper cover 300 toward the bottom surface of the bearing upper cover 300.

In addition, the bearing upper cover 300 may further include the plurality of bearing upper cover fastening holes 311 penetratively formed from the top surface to the bottom surface of the bearing upper cover body 310 so that the fastening members (not illustrated) for fastening the bearing lower cover 400 are inserted into the plurality of bearing upper cover fastening holes 311. In this case, the plurality of bearing upper cover fastening holes 311 may be formed at preset intervals along the circumferential surface of the bearing upper cover body 310 having a disc shape.

Meanwhile, as illustrated in FIG. 5, the bearing lower cover 400 may be fastened to the lower side of the bearing upper cover 300 and provided to support at least a part of the bottom surface of the inner race 120. To this end, the bearing lower cover 400 may further the plurality of bearing lower cover fastening holes 401 penetratively formed from the top surface to the bottom surface of the bearing lower cover 400 so that the fastening members (not illustrated) for fastening the bearing upper cover 300 are inserted into the plurality of bearing lower cover fastening holes 401.

In this case, like the bearing upper cover fastening holes 611, the plurality of bearing lower cover fastening holes 401 may be formed at preset intervals along the circumferential surface of the bearing lower cover 700 having an annular shape.

Therefore, in the caster assembly according to the embodiment of the present disclosure, the fastening members (not illustrated) for coupling the bearing upper cover 300 and the bearing lower cover 400 are inserted into the bearing upper cover fastening holes 311, pass through the bearing lower cover fastening holes 401, and are fixed to the bottom surface of the bearing lower cover 400, such that the bearing upper cover 300 and the bearing lower cover 300, which are coupled to the bearing 100 to surround the top surface, the inner circumferential surface, and the bottom surface of the inner race 120, may rotate together about the rotation axis of the bearing 100 from the outer race 110.

In addition, as illustrated in FIG. 7, the bearing lower cover 400 may further include a second wheel pin insertion groove 404 provided in the bottom surface of the bearing lower cover 400 in a direction toward a central axis of the second wheel pin fixing hole 331 so that a part of the wheel pin 510 for coupling the wheel 500 to the second wheel fastening part 330 may be inserted into the second wheel pin insertion groove 404. Therefore, the caster assembly according to the embodiment of the present disclosure may further minimize a height of the caster assembly from the support surface on which the wheel 500 is supported so that the wheel 500 operates.

Meanwhile, the wheel 500 may be rotatably coupled to the bearing upper cover 300 so as to protrude from the top surface toward the bottom surface of the bearing upper cover 300. To this end, the wheel 500 may include the wheel pin through-hole 501 provided along the rotation axis of the wheel 500, and the wheel pin 510 coupled to the wheel pin through-hole 501 and having two opposite ends fixed to the second wheel pin fixing holes 331. In this case, although not illustrated, the wheel pin 510 may further include a structure such as a groove or a protrusion so that the two opposite ends of the wheel pin 510 may be fixed to the second wheel pin fixing holes 331. In addition, the wheel 500 may further include the bearing provided in the wheel pin through-hole 501 to improve rolling performance.

In addition, in the caster assembly according to the embodiment of the present disclosure, in case that a diameter and a width of the wheel 500 are smaller than a length and a width of the bearing upper cover opening 312, the rotation axis of the wheel 500 may be provided to be high toward the bearing upper cover 300 to further minimize the height of the caster assembly. However, in order to prevent foreign substances from being introduced into a space between the wheel 500 and the bearing upper cover opening 612, the diameter D1 and a width of the wheel 500 may be identical or similar to a length and a width of the bearing upper cover opening 312, as illustrated in FIGS. 7 and 8.

In addition, as described above, the bearing upper cover opening 312 may be formed such that the rotation axis of the bearing 100 and the center of the bearing upper cover opening 312 are disposed on the same perpendicular line, such that the rotation axis of the wheel 500 may perpendicularly intersect the rotation axis of the bearing 100.

In addition, the upper end of the wheel 500 does not protrude from the top surface of the bearing upper cover 300 and the top surface of the bearing casing 200, such that the transport means to which the caster assembly according to the embodiment of the present disclosure is coupled may exclude a structure or the like for preventing contact with the wheel 500.

Therefore, the caster assembly according to the present embodiment may be equipped with the wheel with a sufficient diameter to ensure the traveling performance and durability to smoothly convey the parking robot on which freight with a comparatively heavy weight is loaded. Further, the caster assembly according to the present embodiment may minimize an increase in height caused by a large diameter of the wheel. Therefore, the caster assembly according to the present embodiment may be used for various mobile means, such as transport carriage, wheelchairs, and travel carriers, including the parking robot that moves in the state in which a heavy-weight vehicle is loaded onto the parking robot.

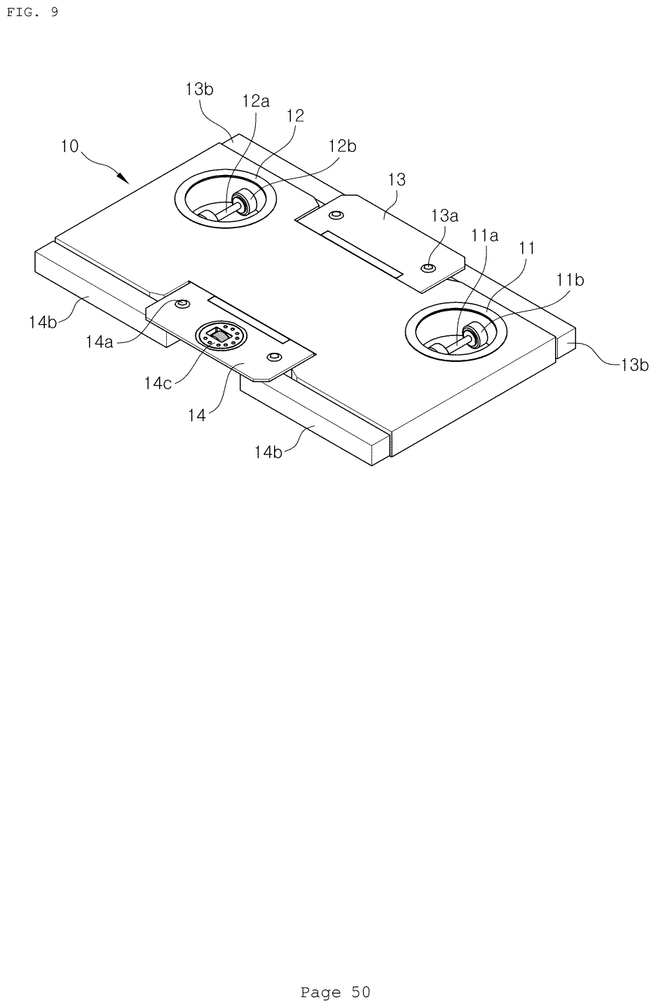

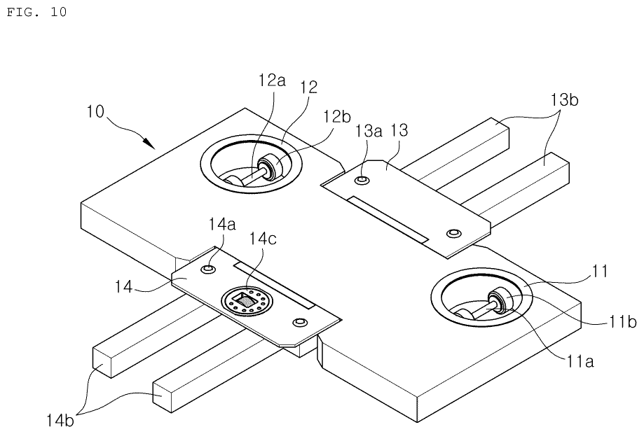

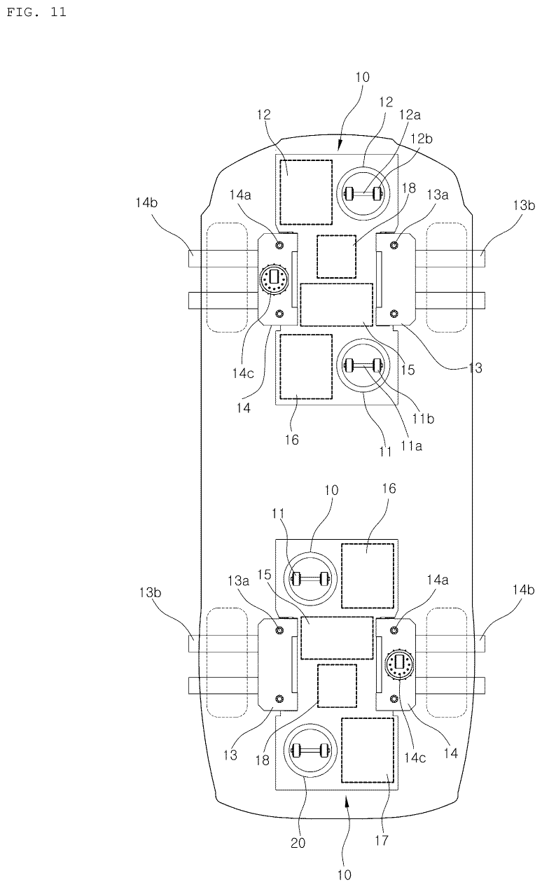

Meanwhile, FIGS. 9 and 10 are perspective views illustrating a non-deployed state and a deployed state of a parking robot including the caster assembly according to the embodiment of the present disclosure. In addition, FIG. 11 is a top plan view illustrating a state in which a vehicle is lifted by the parking robot including the caster assembly according to the embodiment of the present disclosure.

With reference to FIGS. 9 to 10, a parking robot 10 including a caster assembly 14c according to the embodiment of the present disclosure may include a first drive module 11 provided at one side of a front side, a second drive module 12 provided at one side of a rear side, a first lifting module 13 provided between the first drive module 11 and the second drive module 12, and a second lifting module 14 coupled to the caster assembly 14c according to the embodiment of the present disclosure and provided at the other side of the first lifting module 13.

In this case, the parking robot 10 may further include a first control module 16 provided forward of the second lifting module 14, a second control module 17 provided rearward of the second lifting module 13, a battery module 15 provided between the first lifting module 13 and the second lifting module 14 and provided adjacent to the first drive module 11 and the first control module 16, and a third control module 18 provided between the first lifting module 13 and the second lifting module 14 and provided adjacent to the second drive module 12 and the second control module 17.

In addition, although not illustrated, in the parking robot 10 including the caster assembly 14c according to the embodiment of the present disclosure, the first drive module 11 may be provided at a front center side, and the caster assemblies 14c may be respectively provided at two opposite rear sides. Alternatively, the first drive module 11 may be provided at a center side, and the caster assemblies 14c may be respectively provided at two opposite front sides and two opposite rear sides.

More specifically, the first drive module 11 may include two first driving wheels 11b provided at two opposite ends of a first driving shaft 10a disposed in a hole penetratively formed from a top surface to a bottom surface of the first drive module 11, and the two first driving wheels 11b may operate independently of each other. In addition, although not illustrated, the first drive module 11 may further include two drive motors configured to operate the two first driving wheels 11b, respectively.

Meanwhile, the second drive module 12 may include two second driving wheels 11b provided at two opposite ends of a second driving shaft 12a disposed in a hole penetratively formed from a top surface to a bottom surface of the second drive module 12, and the two second driving wheels 12b may operate independently of each other. In addition, although not illustrated, the second drive module 12 may further include two drive motors configured to operate the two second driving wheels 12b, respectively. In this case, the first drive module 11 and the second drive module 12 may have the same configuration and the same structure and be different from each other in terms of positions at which the first drive module 11 and the second drive module 12 are disposed on the parking robot 10.

Meanwhile, the first lifting module 13 may include two first lift bars 13b configured to be simultaneously deployed by being rotated about first rotation shafts 13a respectively provided at front and rear sides of the first lifting module 13. In addition, although not illustrated, the first lifting module 13 may include one drive motor configured to simultaneously rotate the two first lift bars 13b, as described above.

In this case, as illustrated in FIG. 9, the other end side of each of the first lift bars 13b, which is spaced apart from one end side coupled to the first rotation shaft 13a in the non-deployed state, may be disposed at each of a front end side of the first drive module 11 and a rear end side of the second drive module 12. In addition, as illustrated in FIG. 10, the other end side of each of the first lift bars 13b, which is spaced apart from one end side coupled to the first rotation shaft 13a in the deployed state, may be rotated at 90° in a width direction of the parking robot 10.

Meanwhile, the second lifting module 14 may include two second lift bars 14b configured to be simultaneously deployed by being rotated about second rotation shafts 14a respectively provided at front and rear sides of the second lifting module 14. In addition, although not illustrated, the second lifting one drive motor configured to module 14 may include simultaneously rotate the two second lift bars 14b, as described above.

In this case, as illustrated in FIG. 9, the other end side of each of the second lift bars 14b, which is spaced apart from one end side coupled to the second rotation shaft 14a in the non-deployed state, may be disposed at each of a front end side of the first control module 16 and a rear end side of the second control module 17. In addition, as illustrated in FIG. 10, the other end side of each of the second lift bars 14b, which is spaced apart from one end side coupled to the second rotation shaft 14a in the deployed state, may be rotated at 90° in the width direction of the parking robot 10.

In addition, the caster assembly 14c may be disposed between the second rotation shafts 14a respectively provided at the front and rear sides of the second lifting module 14 so that the parking robot 10 may be supported at three points from the ground surface by the first driving wheels 11b, the second driving wheels 12b, and the wheel 500.

More specifically, the bearing casing 200 of the caster assembly 14c may be inserted and coupled into a bearing casing seating portion (not illustrated) from above to below, and the bearing casing seating portion (not illustrated) is recessed downward from the top surface of the second lifting module 14, such that the top surface of the bearing casing 200 does not protrude from the top surface of the second lifting module 14. In this case, the caster assembly 14c may be securely coupled by the fastening members (not illustrated) inserted through the plurality of bearing casing fastening holes 231, which is provided along the outer circumferential surface of the second bearing casing flange 230, and fixed to the bottom surface of the second lifting module 14.

Therefore, when the first drive module 11 and the second drive module 12 operate, the parking robot 10 including the caster assembly 14c according to the present embodiment may be stably moved by the caster assembly 14c configured to move straight or rotate.

Meanwhile, the battery module 15 may be provided in a quadrangular plate shape as a whole. As described above, the battery module 15 may include a battery (not illustrated) provided between the first lifting module 13 and the second lifting module 14, disposed rearward of the first drive module 11 and the first control module 16, and configured to supply necessary power to the first drive module 11, the second drive module 12, the first lifting module 13, the second lifting module 14, the first control module 16, the second control module 17, and the third control module 18.

In addition, the first control module 16 may be provided in a quadrangular plate shape as a whole and disposed at the front side of the parking robot 10 together with the first drive module 11. The first control module 16 may have therein a printed circuit board (PCB) or the like on which various types of electronic elements and the like for controlling the first drive module 11, the second drive module 12, the first lifting module 13, and the second lifting module 14 are mounted.

In addition, the second control module 17 may be provided in a quadrangular plate shape as a whole and disposed at the rear side of the parking robot 10 together with the second drive module 12. The second control module 17 may have therein a printed circuit board (PCB) or the like on which various types of electronic elements and the like for controlling the first drive module 11, the second drive module 12, the first lifting module 13, and the second lifting module 14 are mounted.

In addition, the third control module 18 may be provided in a quadrangular plate shape as a whole, provided between the first lifting module 13 and the second lifting module 14, disposed rearward of the second drive module 12 and the second control module 17. The third control module 18 may have therein a printed circuit board (PCB) or the like on which various types of electronic elements and the like for controlling the first drive module 11, the second drive module 12, the first lifting module 13, and the second lifting module 14 are mounted.

Meanwhile, a method of operating the parking robot 10 including the caster assembly 14c according to the embodiment of the present disclosure configured as described above will be described below with reference to FIGS. 9 to 11.

First, with reference to FIG. 11, the two parking robots 10 enter a space between the ground surface and a bottom surface of a vehicle V and are disposed adjacent to the front wheels FW and the rear wheels RW. In this case, the parking robot 10 cannot enter the space between the ground surface and the bottom surface of the vehicle V when the height of the parking robot 10 is excessively large as the height between the ground surface and the bottom surface of the vehicle V varies depending on the type of vehicle V. In contrast, as described above, the caster assembly 14c according to the embodiment of the present disclosure may prevent the height of the parking robot from being increased by the height of the caster assembly, which may prevent the situation in which the parking robot 10 cannot enter the space between the ground surface and the bottom surface of the vehicle V.

Thereafter, when the two parking robots 10 respectively disposed adjacent to the front wheels FW and the rear wheels RW as described above are deployed, the front wheels FW and the rear wheels RW of the vehicle V are raised by the first lift bars 13b and the second lift bars 14b from the ground surface, such that the parking robot 10 may completely loaded.

Thereafter, the vehicle V is moved to a designated parking space by the two parking robots 10, and then the first lift bars 13b and the second lift bars 14b are returned to the non-deployed state, such that the vehicle may be lowered to the ground surface and completely parked.

Therefore, according to the parking robot including the caster assembly according to the present embodiment, it is possible to exclude a movement passage or the like of the vehicle required for the parking space because of the rotation radius of the vehicle for implementing perpendicular parking, parallel parking, or the like, such that the economical, efficient automatic parking system may be provided.

While the specific embodiments of the caster assembly and the parking robot including the same according to the present disclosure have been described above, it is apparent that various modifications may be made without departing from the scope of the present disclosure.

Therefore, the scope of the present disclosure should not be limited to the described embodiments, and should be defined by not only the claims to be described below, but also those equivalent to the claims.

That is, it should be understood that the aforementioned exemplary embodiments are described for illustration in all aspects and are not limited, and the scope of the present disclosure shall be represented by the claims to be described below, and it should be construed that all of the changes or modified forms induced from the meaning and the scope of the claims, and an equivalent concept thereto are included in the scope of the present disclosure.

What is claimed is:

1. A caster assembly comprising:
a bearing configured such that an inner race rotates relative to an outer race;
a bearing casing to which the bearing is fixedly coupled so that at least a part of the outer race is supported on an inner circumferential surface of the bearing casing;
a bearing upper cover provided to surround at least a part of the inner race, except for a bottom surface of the inner race, and rotatably coupled to the inner circumferential surface of the bearing casing;
a bearing lower cover provided to support at least a part of the bottom surface of the inner race and fastened to a lower side of the bearing upper cover; and
a wheel protruding downward from a top surface of the bearing upper cover and rotatably coupled to the bearing upper cover or the bearing lower cover.

2. The caster assembly of claim 1, wherein the bearing casing comprises:
a bearing casing body configured to support an outer circumferential surface of the outer race; and
a first bearing casing flange protruding inward from an upper portion of the bearing casing body and configured to support a top surface of the outer race.

3. The caster assembly of claim 2, wherein the bearing casing comprises:
a second bearing casing flange protruding outward from a lower portion of the bearing casing body; and
a plurality of bearing casing fastening holes penetratively formed from a top surface to a bottom surface along a circumferential surface of the second bearing casing flange.

4. The caster assembly of claim 1, wherein the bearing upper cover comprises:
a bearing upper cover body having a disc shape and configured to support an inner circumferential surface of the inner race;
a bearing upper cover flange protruding outward from an upper portion of the bearing upper cover body and configured to support a top surface of the inner race; and
a bearing upper cover opening penetratively formed from a top surface to a bottom surface of the bearing upper cover body so that at least a part of the wheel is disposed in the bearing upper cover opening.

5. The caster assembly of claim 4, wherein the bearing upper cover further comprises a plurality of bearing upper cover fastening holes penetratively formed from the top surface to the bottom surface of the bearing upper cover body so that fastening members for fastening the bearing lower cover are inserted into the plurality of bearing upper cover fastening holes.

6. The caster assembly of claim 1, wherein the bearing lower cover comprises:
a bearing lower cover opening penetratively formed from a top surface to a bottom surface of the bearing lower cover so that at least a part of the wheel is disposed in the bearing lower cover opening;
first wheel fastening parts respectively provided at two opposite sides of the bearing lower cover opening and protruding downward from the bottom surface of the bearing lower cover; and
first wheel pin fixing holes penetratively formed from one side to the other side of the first wheel fastening part, and
wherein the bearing lower cover is provided in a disc shape.

7. The caster assembly of claim 6, wherein the bearing lower cover further comprises a plurality of bearing lower cover fastening holes penetratively formed from the top surface to the bottom surface of the bearing lower cover so that fastening members for fastening the bearing upper cover are inserted into the plurality of bearing lower cover fastening holes.

8. The caster assembly of claim 6, wherein the wheel comprises:
a wheel pin through-hole provided along a rotation axis of the wheel; and
a wheel pin coupled to the wheel pin through-hole and having two opposite ends fixed to the first wheel pin fixing holes.

9. The caster assembly of claim 8, wherein a diameter of the wheel is equal to a length of a bearing upper cover opening penetratively formed from the top surface to the bottom surface of the bearing upper cover so that at least a part of the wheel is disposed in the bearing upper cover opening, and
wherein the diameter of the wheel is equal to a length of a bearing lower cover opening penetratively formed from the top surface to the bottom surface of the bearing lower cover so that at least a part of the wheel is disposed in the bearing lower cover opening.

10. The caster assembly of claim 8, wherein the bearing lower cover further comprises a first wheel pin insertion groove provided in the bottom surface of the bearing lower cover in a direction toward a central axis of the first wheel pin fixing hole so that a part of the wheel pin is inserted into the first wheel pin insertion groove.

11. The caster assembly of claim 4, wherein the bearing upper cover further comprises:
second wheel fastening parts respectively provided at two opposite sides of the bearing upper cover opening and protruding downward from the bottom surface of the bearing upper cover body; and
second wheel pin fixing holes penetratively formed from one side to the other side of the second wheel fastening part.

12. The caster assembly of claim 11, wherein the bearing lower cover comprises a plurality of bearing lower cover fastening holes penetratively formed from the top surface to the bottom surface of the bearing lower cover so that fastening members for fastening the bearing upper cover are inserted into the plurality of bearing lower cover fastening holes.

13. The caster assembly of claim 11, wherein the wheel comprises:
a wheel pin through-hole provided along a rotation axis of the wheel; and
a wheel pin coupled to the wheel pin through-hole and having two opposite ends fixed to the second wheel pin fixing holes.

14. The caster assembly of claim 13, wherein the bearing lower cover further comprises a second wheel pin insertion groove provided in the bottom surface of the bearing lower cover in a direction toward a central axis of the second wheel pin fixing hole so that a part of the wheel pin is inserted into the second wheel pin insertion groove.

15. The caster assembly of claim 13, wherein a diameter of the wheel is equal to a length of the bearing upper cover opening.

16. A parking robot, which comprises the caster assembly according to claim 1 and is configured to enter a front wheel side and a rear wheel side of a vehicle, lift the vehicle from a ground surface, and then transport the vehicle to a designated parking location, the parking robot comprising:
a first drive module provided at one side of a front side;
a second drive module provided at one side of a rear side;
a first lifting module provided between the first drive module and the second drive module; and
a second lifting module coupled to the caster assembly and provided at the other side of the first lifting module.

17. The parking robot of claim 16, wherein the first drive module comprises two first driving wheels provided at two opposite ends of a first driving shaft and configured to operate independently of each other,
wherein the second drive module comprises two second driving wheels provided at two opposite ends of a second driving shaft and configured to operate independently of each other, and
wherein the parking robot is configured to move straight or rotate in accordance with rotations of the first and second driving wheels.

18. The parking robot of claim 16, wherein the first lifting module comprises two first lift bars configured to be simultaneously deployed by being rotated about first rotation shafts provided at front and rear sides of the first lifting module,
wherein the second lifting module comprises two second lift bars configured to be simultaneously deployed by being rotated about second rotation shafts provided at front and rear sides of the second lifting module, and
wherein the parking robot is configured to lift the vehicle from the ground surface when the first lift bars and the second lift bars are deployed.

19. The parking robot of claim 16, wherein the caster assembly is formed such that a top surface of the bearing casing and a top surface of the bearing upper cover are formed at the same height as a top surface of the second lifting module.

20. The parking robot of claim 16, further comprising:
a first control module provided forward of the second lifting module;
a second control module provided rearward of the second lifting module;
a battery module provided between the first lifting module and the second lifting module and provided adjacent to the first drive module and the first control module; and
a third control module provided between the first lifting module and the second lifting module and provided adjacent to the second drive module and the second control module.
